(19) United States
(12) Patent Application Publication
(10) Pub. No.: US 2026/0135222 A1
(43) Pub. Date: May 14, 2026

(54) SYSTEMS AND METHODS FOR BATTERY BIASING ARRANGEMENTS FOR A POWER TOOL

(71) Applicant: Milwaukee Electric Tool Corporation, Brookfield, WI (US)

(72) Inventors: Spencer D. Stingl, Wauwatosa, WI (US); Jonathan J. Christian, Greenfield, WI (US); Kevin A. McLachlan, Brookfield, WI (US); Ye Shun Liu, Dongguan City (CN); Yong Quan Lin, Dongguan City (CN); Jun Qiang Liu, Dongguan City (CN)

(21) Appl. No.: 19/387,031

(22) Filed: Nov. 12, 2025

Related U.S. Application Data
(60) Provisional application No. 63/720,365, filed on Nov. 14, 2024.

(51) Int. Cl. H01M 50/242; B25D 17/02; B25D 17/24; H01M 50/247

(52) U.S. Cl. CPC H01M 50/242; B25D 17/02; B25D 17/24; H01M 50/247; B25D 2217/0073

(57) ABSTRACT

A power tool includes a housing including a battery receptacle that is configured to receive a battery pack. A biasing assembly is coupled to the housing. The biasing assembly includes a plunger including a catch configured to engage with a stop. A bumper is coupled to the plunger. An actuator is coupled to the housing and configured to translate the plunger between a first position in which the bumper is disengaged from the battery pack and a second position in which the bumper is engaged with the battery pack to dampen vibrations between the battery pack and the battery receptacle.

### CROSS-REFERENCE TO RELATED APPLICATIONS

This application claims priority to and the benefit of U.S. Provisional Application No. 63/720,365, filed on Nov. 14, 2024, which is incorporated herein by reference in its entirety.

### BACKGROUND

A power tool (e.g., a rotary hammer, an air hammer, a drill, air chisel, etc.) can be used to drill or impact a workpiece with a bit (e.g., to remove material from the workpiece). An output unit of the power tool can include an impact mechanism that provides power to translate the bit in an axial (i.e., linear) direction. For example, in some applications, the impact mechanism can include a striker that translates in the axial direction to deliver an impact to a tool bit (e.g., via an anvil).

### SUMMARY

According to one aspect of the present disclosure, a power tool can include a housing including a battery receptacle that can be configured to receive a battery pack. A biasing assembly can be coupled to the housing. The biasing assembly can include a plunger including a catch configured to engage with a stop, a bumper coupled to the plunger, and an actuator coupled to the housing and configured to translate the plunger between a first position in which the bumper can be disengaged from the battery pack and a second position in which the bumper can be engaged with the battery pack to dampen vibrations between the battery pack and the battery receptacle.

In some examples, the actuator can be coupled to the battery receptacle.

In some examples, the actuator can be rotatable relative to the battery receptacle.

In some examples, the actuator can translate the plunger in a direction that can be orthogonal to an insertion direction of the battery receptacle.

In some examples, the actuator can translate the plunger in a direction parallel to an insertion direction of the battery receptacle.

In some examples, the power tool can further include an arm that can be moved by the actuator in a direction that can be orthogonal to the insertion direction, the arm including a first cam surface that can engage a second cam surface on the plunger.

In some examples, the actuator can be a trigger configured to operate a motor of the power tool, the trigger actuating the biasing assembly to the second position when the trigger can be pressed to run the motor and the trigger actuating the biasing assembly to the first position when the trigger can be released.

In some examples, the plunger can include a first end coupled the actuator, a second end coupled to the bumper, and a catch can be positioned between the first end and the second end, the catch engaging the housing in the second position to limit movement of the plunger.

In some examples, the power tool can further include a biasing member positioned between the housing and the first end of the plunger, the biasing member being compressed when the trigger can be pressed to move the biasing assembly to the second position, and the biasing member decompressing to move the trigger and return the biasing assembly to the first position when the trigger can be released.

According to another aspect of the present disclosure, a power tool configured to impart impacts to a tool bit can include a housing defining a battery receptacle configured to receive a battery pack, the battery receptacle including a tool-side engagement feature that can engage a battery-side engagement feature on the battery pack to guide movement of the battery along an insertion direction. A motor can be disposed within the housing. A spindle can be disposed within the housing and rotatable by the motor. An impact mechanism can include a piston at least partially received within the spindle for reciprocation therein and a striker that can reciprocate in response to reciprocation of the piston. A biasing assembly can be coupled to the housing and can be moveable between a first configuration in which the biasing assembly can be disengaged from the battery pack and a second configuration in which the biasing assembly can be engaged with the battery pack to apply a biasing force that can force the battery-side engagement feature into contact with the tool-side engagement feature.

In some examples, the biasing force can be applied to a battery pack housing and can be applied substantially orthogonal to the insertion direction.

In some examples, the housing can include a handle defining a handle axis that can extend from a first end of the handle to a second end of the handle, the biasing force being applied in a direction that can be substantially parallel to the handle axis.

In some examples, the biasing assembly can include a plunger that can engage with the battery pack in the second configuration and a user interface that can be moveable between a first position to place the biasing assembly in the first configuration and a second position to place the biasing assembly in the second configuration.

In some examples, the biasing assembly can include a bumper coupled to the plunger to engage with the battery pack.

In some examples, the bumper can include dimples that can engage the battery pack.

In some examples, the user interface can be a trigger of the power tool that can control a supply of electrical current to the motor.

In some examples, the user interface can be a lever that can be actuated independent of a trigger of the power tool.

In some examples, the user interface can be a cam lever that can rotate to move the plunger to move the biasing assembly between the first configuration and the second configuration.

According to yet another aspect of the present disclosure, a method of operating a power tool can include actuating a trigger to operate a motor of the power tool, the motor positioned within a housing that can define a battery receptacle configured to receive a battery. The method can include moving a biasing assembly to a first position relative to the housing where the biasing assembly can be configured to disengage the battery when the battery can be received in the battery receptacle. The method can include moving the biasing assembly to a second position relative to the housing where the biasing assembly can be configured to engage the battery to dampen vibrations between the battery and the housing when the battery can be received in the battery receptacle.

### BRIEF DESCRIPTION OF THE DRAWINGS

The accompanying drawings, which are incorporated in and form a part of this specification, illustrate examples of the disclosed technology and, together with the description, serve to explain the principles of examples of the disclosed technology:

FIG. 1 is a side view of an example power tool according to aspects of the disclosure.

FIG. 2 is a partial cross-sectional view of the power tool of FIG. 1.

FIG. 3 is a detail view of a battery clamp for use with the power tool of FIG. 1, the battery clamp being in a first configuration.

FIG. 4 is a detail view of the battery clamp of FIG. 3 in a second configuration.

FIG. 5 is an axonometric view of the battery clamp of FIG. 3 with an actuator.

FIG. 6 is a detail view of another example of a battery clamp for use with the power tool of FIG. 1, the battery clamp being in a first configuration.

FIG. 7 is a detail view of the battery clamp of FIG. 6 in a second configuration.

FIG. 8 is a detail view of still another a battery clamp for use with the power tool of FIG. 1, the battery clamp being in a first configuration.

FIG. 9 is a detail view of the battery clamp of FIG. 8 in a second configuration.

### DETAILED DESCRIPTION

The following discussion is presented to enable a person skilled in the art to make and use embodiments of the disclosed technology. Given the benefit of this disclosure, various modifications to the illustrated examples will be readily apparent to those skilled in the art, and the principles herein can be applied to other examples and applications without departing from examples of the disclosed technology. Thus, examples of the disclosed technology are not intended to be limited to examples shown but are to be accorded the widest scope consistent with the principles and features disclosed herein.

As generally noted above, a power tool (e.g., a rotary hammer, demolition hammer, hammer chisel, etc.) can be provided with an impact mechanism that can provide impacts (e.g., axial impacts) to a tool bit. The impact mechanism can include a piston that moves between extended and retracted position within a chamber of a spindle. In some applications (e.g., a rotary hammer), the spindle can rotate about a drive axis to further cause a rotation of the bit. Within the chamber, a striker can be positioned between an end of the piston and the tool bit to form an air cushion therebetween. Extension of the piston into the chamber can cause pressure within the chamber (e.g., of the air cushion) to increase. This increase in pressure causes the striker to move forward in a linear direction (e.g., in the direction of extension of the piston, along a drive axis of the power tool). The striker can impact an anvil, which in turn contact the tool bit to cause a bit that is secured to the anvil to impact a workpiece. In some examples, the striker may contact the tool bit to impart an impact.

The present disclosure provides a power tool with a battery biasing arrangement (e.g., a battery biasing assembly) that can improve tool performance and longevity. For example, in some cases, a power tool can include a battery biasing assembly that is configured to bias a battery to reduce relative movement between the battery and the tool body (e.g., a battery receptacle). More specifically, a battery biasing assembly can apply a force (e.g., a biasing force) to a battery housing to bias the battery away from a battery receptacle (e.g., in a direction away from the battery receptacle and substantially perpendicular to a sliding direction of the battery). The force can cause battery-side engagement features (e.g., rails, rollers, pins, etc.), already in contact with corresponding tool-side engagement features (e.g., rails, rollers, pins, etc.), to be biased away from the housing, or further secured to each other (e.g., generally, the battery-side engagement features are in contact, or secured, to the tool-side engagement features, so applying the biasing force may press the engagement features together). In doing so, the frictional force between the battery-side engagement features and the tool-side engagement feature can resist relative movement between the battery and the power tool, as may result from impact forces or other vibrations from tool operation. This in turn reduces movement between battery-side terminals (e.g., pins, contacts, or other electrical components) and tools-side terminals (e.g., terminal block, pins, other electrical components) that provide an electrical connection between the battery and the power tool, and reduces wear on the terminals (e.g., due to fretting, arcing, oxidation, pitting, etc.) to ensure a good electrical connection. By ensuring a good electrical connection, operating temperatures can be better controlled because electrical resistance remains lower, which reduces heat generation and decreases the chance of a shutdown of the power tool due to high temperatures.

Generally, examples of the disclosed technology can be implemented on any variety of power tools that operate with removable bits. In particular, some examples may be used with impact drivers, including rotary hammers, chisel hammers or other known implementations. Rotary hammers are power tools that are configured to impart both rotational motion and axial impacts to a tool bit, independently or simultaneously. In general, a rotary hammer includes a housing having a handle at a first end of the housing and an output assembly at a second end of the housing that is opposite the first end. The handle generally includes a trigger (e.g., actuator) that is actuatable by an operator to control operation of the rotary hammer. However, the power tool may include other means of controlling the operation of the rotary hammer, such as a switch, a lever, or other means of control. The housing defines a first direction (e.g., a longitudinal direction, which may correspond with a longitudinal axis) extending between the first end and the second end. A motor is disposed in the housing and is operatively coupled to the output assembly having an output end (e.g., the first end). The output assembly includes a drive system (e.g., a reciprocation drive assembly) that is configured to convert rotational motion of the motor to impart both rotational motion and axial impacts of a tool bit. Said differently, the output assembly includes a drive system that converts rotational motion of the motor into both rotational motion and axial impacts of a tool bit. Correspondingly, the output end can include a chuck (e.g., a tool holder) that holds the tool bit during operation. The chuck is coupled to a spindle that rotates the tool bit about a spindle axis and an axial impact mechanism (e.g., impact mechanism) to impart axial impacts to the tool bit.

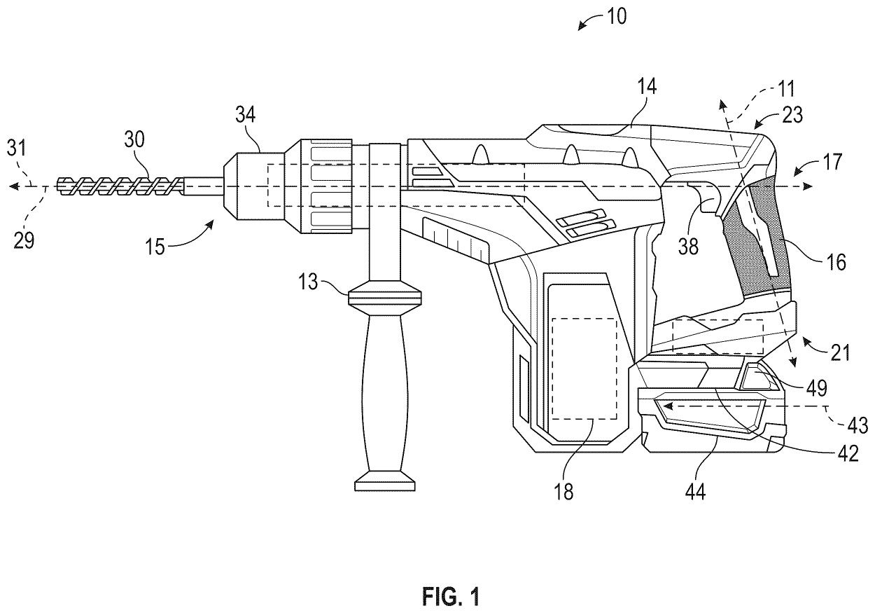

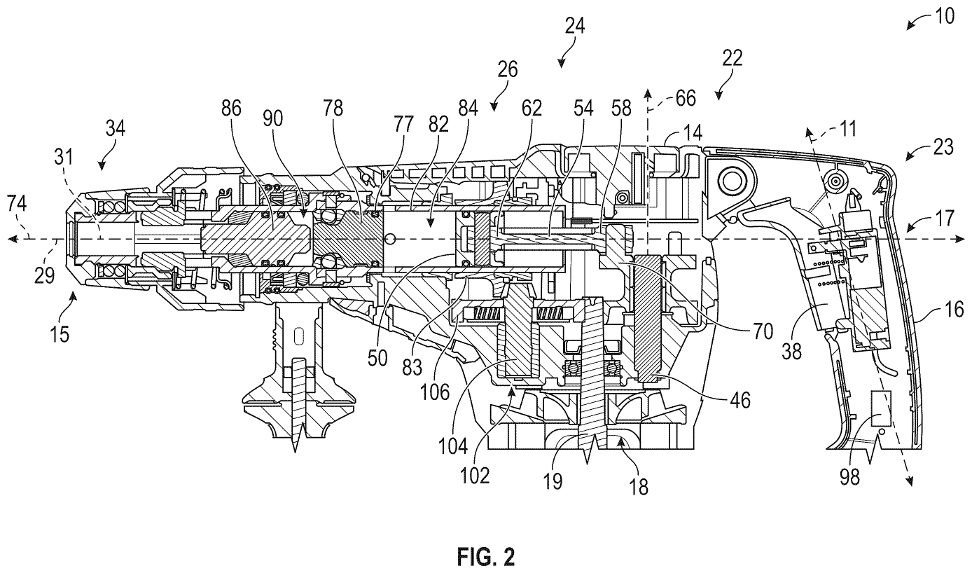

In this regard, for example, FIGS. 1 and 2 illustrate a power tool 10 in the form of a rotary hammer; however, aspects of the disclosure can be used with other types of power tools. The power tool 10 can include a housing 14 and a motor 18 disposed within the housing 14. The power tool 10 can further include an output assembly 24 disposed within the housing 14. The output assembly 24 includes a reciprocation drive assembly 22 (shown in FIG. 2) coupled to the motor 18 for converting torque from the motor 18 to reciprocating motion. The output assembly 24 can further include an impact mechanism 26 (e.g., axial impact mechanism) that can be coupled to the reciprocation drive assembly 22 to impart repeating axial impacts on a tool bit 30 (e.g., a chisel bit). The transmission 102, reciprocation drive assembly 22, and impact mechanism 26 are discussed in greater detail below.

In some aspects, the power tool 10 can include a means of supporting the tool bit. For example, the tool bit 30 may be slidably supported by a tool holder 34 coupled to the housing 14 such that the tool bit 30 is permitted to translate along its axis to impart the axial impacts to a work piece. Further, as shown in FIG. 1, the tool bit 30 is slidably supported by the tool holder 34 at a first end 15 (e.g., a front end) of the power tool 10. The tool bit 30 may be inserted into the tool holder 34 along an insertion direction 29 (e.g., a tool bit insertion direction). In some examples, the insertion direction 29 is substantially parallel to a bottom side of a battery pack 44.

Opposite the first end 15 of the power tool 10 is a second end 17 (e.g., a rear end, a handle end, a user end, etc.). A first direction 31 extends between the first end 15 and the second end 17. The insertion direction 29 extends parallel to the first direction 31. In other examples, the insertion direction 29 extends in a non-parallel (e.g., a non-parallel orientation relative) to the first direction 31.

The second end 17 includes a handle 16. However, in some examples, the handle 16 may be located on the housing between the first end 15 and the second end 17. The handle 16 defines a first end 21 (e.g., a first end of the handle, a bottom end) and a second end 23 (e.g., a second end of the handle, a top end), opposite the first end 21. In some examples, such as the example power tool 10 of FIGS. 1 and 2, the power tool 10 can include a side handle 13 that is selectively coupled to the housing 14. In some examples, the side handle 13 may be located between the first end 15 and the second end 17 of the power tool 10. Further, in some examples, the side handle 13 may be located between the tool holder 34 and the handle 16.

In some non-limiting examples, the handle 16 defines a handle axis 11. In some examples, the handle axis 11 is substantially perpendicular to the first direction 31. In other examples, the handle axis 11 is substantially parallel to the first direction 31 of the tool bit 30.

In some aspects, the motor 18 can be a direct-current (DC) motor and is positioned (e.g., disposed) within the housing of the power tool. In other aspects, the motor 18 can be any other type of motor. Generally, the motor 18 receives power from a power source of the power tool.

Generally, power tools (e.g., the power tool 10) include a power source that provides a power source to a motor. In some aspects, the power source is a battery that can be selectively coupled and decoupled from the power tool. In such examples, the power tool includes tool-side engagement features and the battery includes battery-side engagement features that are in contact when the battery is coupled to the power tool. Once the battery is coupled within the power tool via insertion into a battery receptacle, tool-side terminals and the battery-side terminals may be arranged such that the respective terminals are in contact, supplying the power tool with power (e.g., supply the motor 18 with electrical current). In other examples, the battery-side terminals and tool-side terminals may be arranged to be proximate another, such that, upon actuation of user interface of the power tool, the battery-side and tool-side terminals are in contact and supply the power tool with power.

For example, in the illustrated construction of the power tool 10 shown in FIGS. 1 and 2, the motor 18 receives power from an on-board power source (e.g., the battery pack 44). The housing 14 can define a battery receptacle 42 that detachably receives the battery pack 44. In some cases, one of the battery pack 44 and the battery receptacle 42 can include a latch 49 that locks the battery pack 44 to the battery receptacle 42. The user can depress the latch 49 to allow the battery pack 44 to be decoupled from the battery receptacle 42. The battery pack 44 can include any of a number of different nominal voltages (e.g., 12V, 18V, etc.). The battery pack 44 can be configured having a Lithium-based chemistry (e.g., Lithium, Lithium-ion, etc.) or any other suitable chemistry.

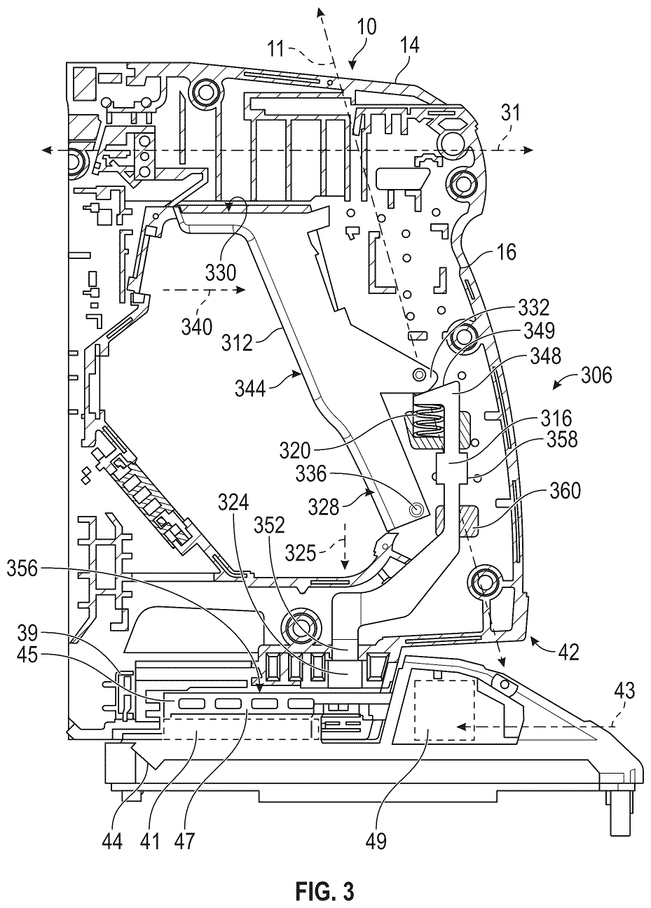

With respect to the power tool 10, the battery receptacle 42 is disposed on the housing 14, adjacent the handle 16. More specifically, the battery receptacle 42 is provided at the first end 21 of the handle 16. In other examples, the battery pack 44 can be positioned differently on the handle 16. Further, in other examples, the battery pack 44 can be positioned differently on the housing 14. The battery pack 44 is slidably engaged with the battery receptacle 42 along an insertion direction 43 (e.g., a battery pack insertion direction). When the battery pack 44 is slidably engaged with the battery receptacle 42, battery-side engagement features 45 (e.g., rails, rollers, pins, etc.) of the battery pack 44 contact (e.g., are secured to) tool-side engagement features 41 (e.g., rails, rollers, pins, etc.) of the power tool 10 (see, e.g., at least FIG. 3). In some examples, as shown in FIG. 1, the insertion direction 43 is substantially parallel to the insertion direction 29. In other examples, the insertion direction 43 may be transverse to the insertion direction 29 or can be at another angle.

The motor 18 is selectively activated by manipulating a user interface (e.g., a trigger, button, etc.) to control a flow of electrical current to the motor 18. Specifically, and as discussed above, manipulating the user interface contacts the battery-side engagement features and tool-side engagement features, supplying a flow of electrical currently to the motor 18 from the battery pack 44. For example, as shown in FIGS. 1 and 2, the power tool includes a trigger 38 (e.g., a trigger of an interface) that is provided on the handle 16. The trigger 38 may be depressed by a user and a controller 98 can control a flow of electrical current to the motor 18 from the battery pack 44 based on the movement of the trigger 38. The controller 98 can be a top-level or master controller 98 (e.g., a microcontroller) that includes or one or more circuits for controlling operation of the motor 18. The controller 98 can be configured to implement proportional, stepped, or another type of control scheme based on operation of the trigger 38.

In some examples, the reciprocation drive assembly 22 can be realized by other mechanisms, including those known in the art to convert rotational motion to reciprocating motion (e.g., a scotch-yoke mechanism, a wobble drive mechanism, a swash plate mechanism, etc.). Specifically, the reciprocation drive assembly 22 can be configured as a slider crank mechanism that converts a rotational output of the motor 18 to an axial impact. For example, and as shown in FIG. 2, the reciprocation drive assembly 22 converts a rotational output of the motor to an axial impact of the tool bit 30. The reciprocation drive assembly 22 includes a crankshaft 46, a reciprocating piston 50, and a connecting rod 54 pivotably coupled to the crankshaft 46 at a first end 58 and pivotably coupled to the piston 50 at a second end 62. The crankshaft 46 can receive torque (e.g., rotational output) from the motor 18 and rotate about a crankshaft axis 66. Specifically, the crankshaft 46 can receive torque from a motor shaft 19. The motor shaft 19 outputs a rotational output of the motor 18. The crankshaft 46 can include a crank pin 70 that couples to the first end 58 of the connecting rod 54. In some examples, reciprocation drive assembly 22 can operate while a spindle 82 (e.g., barrel) is stationary or when the spindle 82 is rotated by the motor 18 to cause rotation of a tool bit.

As the crankshaft 46 rotates about the crankshaft axis 66, the connecting rod 54 can drive the piston 50 to reciprocate along a reciprocation axis 74 and within the spindle 82 supported within the housing 14. In some examples, the reciprocation axis 74 is substantially parallel to the insertion direction 29. In other examples, the reciprocation axis 74 is substantially parallel to the first direction 31. Further, in some examples, the reciprocation axis 74 is substantially perpendicular to the handle axis 11.

Generally, a rotary hammer may also include a transmission that rotates the spindle 82, which rotates the tool bit 30. Thus, the rotary hammer is capable of supplying rotation and axial impacts to the tool bit 30 via the output assembly 24. Specifically, the transmission transfers the torque from the motor 18 to the spindle 82. For example, the power tool 10 includes a transmission 102 to rotate the spindle 82, as shown in FIG. 2. The transmission 102 is located within the housing 14, between the first end 15 and the second end 17. The transmission 102 can include a geartrain, although other types of transmission systems can be used, for example, belt drives, chain drives, etc. The transmission includes a first gear 106 and a jack shaft 104. The first gear 106 rotates with the jack shaft 104, and the jack shaft 104 mates with a second gear 83 of the spindle 82 (e.g., via a pinion formed on the jack shaft 104. Thus, when the motor 18 shaft supplies torque (e.g., rotational output) to the first gear 106, the jack shaft 104 supplies torque to the second gear 83, which rotates the spindle 82.

In some examples, the first gear 106 is integrally formed with the jack shaft 104. In some examples, the first gear 106 can be a spur gear. In other examples, the first gear 106 may be a bevel gear. Similarly, in some examples, the second gear 83 may be a worm gear. In other examples, the second gear 83 may be any other type of gear.

As discussed above, the impact mechanism 26 imparts repeating axial impacts with the tool bit 30. Specifically, the impact mechanism, 26 converts the torque supplied by the motor via the motor shaft 19 to axial movement (e.g., reciprocation) of a spindle. The impact mechanism 26 includes components that assist with imparting axial impacts with the tool bit 30, such as a striker 78 and an anvil 86. The striker 78 selectively reciprocates within the spindle 82 in response to reciprocation of the piston 50. Thus, the anvil 86 is impacted by the striker 78 when the striker 78 reciprocates toward the tool bit 30. The impact between the striker 78 and the anvil 86 can be transferred to the tool bit 30, causing the tool bit 30 to reciprocate for performing work on a work piece (e.g., impact a workpiece).

In some examples, the spindle 82 is moveably receives the piston 50 and the striker 78. An air spring 84 (e.g., an air pocket or an air cushion) can be formed between the piston 50 and the striker 78 when the piston 50 reciprocates within the spindle 82, whereby expansion and contraction of the air spring 84 induces reciprocation of the striker 78. That is, as the piston 50 moves towards the striker 78, the volume of the air spring 84 is reduced, which increases pressure within the air spring 84. This increase in pressure can be sufficient to move the striker 78 in the same direction as piston 50 and causes the striker 78 to impact the anvil 86 to deliver an impact to a workpiece via the tool bit 30. Conversely, as the piston 50 moves away from the striker 78, the volume of the air spring 84 can increase, which reduces pressure within the air spring 84. This reduction in pressure can be sufficient to move the striker 78 in the same direction as piston 50, causing the striker 78 to retract and move away from the anvil 86.

In some cases, the striker 78 or the anvil 86 can form a seal against an interior surface of the spindle 82 via sealing rings 77 (e.g., an O-ring). In some examples, maintaining the seal between the striker 78 and the spindle 82 can help to maintain the air spring 84 formed within the interior chamber 90. In some configurations, the spindle 82 can include openings (e.g., on a piston side of the spindle 82) that can allow for “make-up” air to be provided in the interior chamber 90 if air is lost across the sealing rings 77 during reciprocation of the piston 50. That is, if a seal between the striker 78 and the piston 50 breaks and allows air to escape, replacement air can enter through the openings to form the air spring 84.

During operation of the power tool, impacts from the impact mechanism 26 or other vibrations can be transferred into the power tool 10. In some cases, this can result in relative movement between the battery pack 44 and the housing 14 of the power tool 10. Such relative movement can result in relative movement between the battery side engagement features and the tool-side engagement features. Correspondingly, relative motion between battery-side terminals and tool-side terminals (e.g., a terminal block) may occur. To reduce this relative movement between the battery pack 44 and the housing 14, a power tool can include a biasing arrangement to resist the relative movement. Generally, biasing arrangements can apply a force to housing of the battery pack 44. In general, the biasing arrangement can be configured to apply a force to a battery in a biasing direction. In accordance with the illustrated example, the force is applied in the biasing direction such that the battery pack 44 is biased in a direction away from the housing (e.g., away from the battery receptacle) so that the battery-side engagement features are forced in to contact with the tool-side engagement features. In some cases, the biasing force is applied substantially parallel to an extension direction of the handle (e.g., a direction extending from the first end 21 of the handle to the second end 23 of the handle). In other examples, the biasing force can be applied in a direction substantially perpendicular to the handle.

In general, a battery biasing arrangement can include a plunger that can be moved by a user between a first configuration (e.g., a disengaged configuration or position) and a second configuration (e.g., an engaged configuration or position). The biasing arrangement can include an interface (e.g., a lever, slide, button, electronic switch, etc.) that can be manipulated by a user to move the plunger between the first configuration and the second configuration. In the first configuration, the plunger can be moved out of contact with the battery pack 44 (e.g., a housing of the battery pack) so that the battery pack 44 can be coupled or decoupled from the battery receptacle 42. Accordingly, the plunger may not apply a biasing force to the battery pack 44 in the first configuration. In the second configuration, and with the battery pack 44 coupled to the battery receptacle 42, the plunger can be moved into contact with the battery pack 44 to apply the biasing force to the battery pack 44. The biasing force causes the battery-side engagement features to be forced into contact with the tool-side engagement features, thereby limiting relative movement between the battery pack and the tool receptacle. This in turn can limit relative movement between the battery side terminals and the tool side terminals. In some cases, the biasing force can cause the battery-side terminals to contact the tool-side terminals in the second configuration. In other examples, the battery-side terminals are in contact with the tool-side terminals in the first configuration, thus, the biasing force further contacts the battery-side terminals with the tool-side terminals, further securing the electrical connection between the terminals.

As described in greater detail below, biasing assemblies can be configured in a variety of ways without departing from the principles of this disclosure. In some cases, a plunger can be a plunger assembly that includes multiple plungers. In some cases, a plunger can include a bumper that engages with battery pack. A bumper can be a resilient material that resiliently compress when the plunger is moved to the second configuration, as may attenuate vibrations further and ensure the biasing force remains applied to the battery pack during operation of the power tool. A bumper can also be configured to ensure that the magnitude of the biasing force remains substantially constant as a user manipulates an interface.

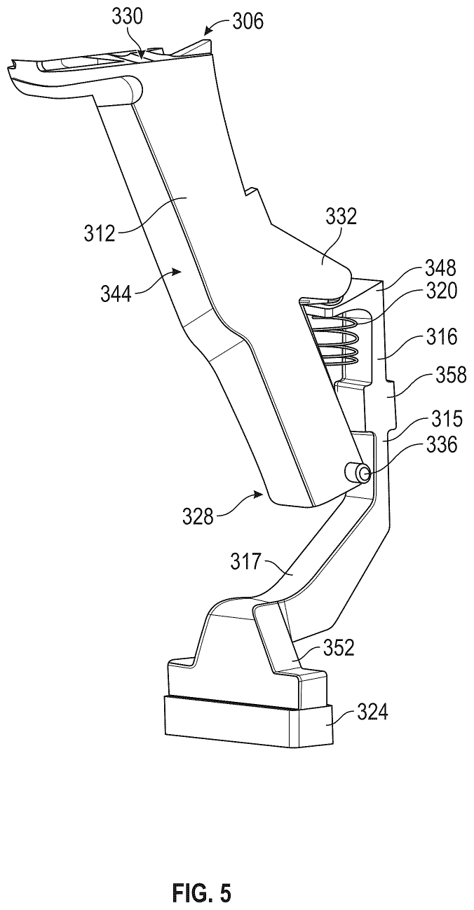

In some cases, a biasing assembly can be operated by a trigger of a power tool. In such cases, actuation of the trigger to activate the power tool can move a plunger from a first configuration to a second configuration to apply a biasing force to the battery. For example, FIGS. 3-5 illustrate an example of a battery clamp assembly 306 (e.g., biasing assembly, clamp, battery clamp, relative motion limiter) that biases the battery pack 44 away from the housing 14 of the power tool 10 (e.g., a rotary hammer, demolition hammer, a drill, etc.).

In the embodiment shown in FIGS. 3-5, the biasing assembly 306 includes a plunger 316 and a biasing component 320 (e.g., a spring or other resilient member) at a first end 348 of the plunger 316. As shown, the biasing component 320 is coupled to the housing 14 and contacts the first end 348 of the plunger 316. In some examples, the biasing component 320 is a coil spring. The biasing component 320 can also be another type of resilient member, for example, a bumper.

In some examples, the plunger 316 includes a bumper 324 (e.g., an interface, resilient member, etc.) at a second end 352 that is opposite the first end 348. Further, in some examples, the plunger 316 may include catches 358. The catches 358 may be spaced from the first end 348 of the plunger 316. In some examples, the catches 358 may disposed along the plunger 316 at any location.

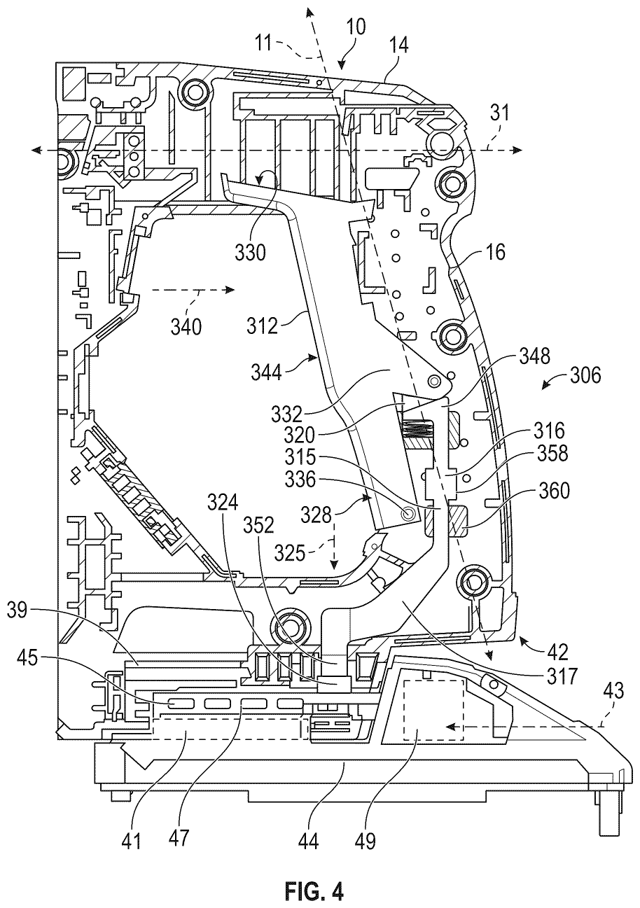

In some aspects, the plunger 316 may be configured to translate within the handle 16. As such, the plunger 316 may be a non-linear shape, as shown in FIGS. 3-5. The non-linear shape of the plunger 316 allows the plunger 316 to translate within the handle 16 as the biasing assembly 306 move between a first configuration shown in FIG. 3 and a second configuration shown in FIG. 4. Said differently, the non-linear shape of the plunger 316 allows the plunger 316 to extend between an actuator 312 (e.g., the trigger 38 or other interface) and a battery-side terminal 47 of the battery pack 44. The plunger 316 can also include a first leg 315 and a second leg 317. The first leg 315 may be a substantially linear in shape, as shown in FIG. 3. However, in some examples, the first leg 315 may be substantially non-linear in shape to allow the plunger 316 to translate within the housing 14, or the handle 16, and extend between the actuator 312 and the battery-side terminal 47. The first leg 315 includes the first end 348, where the first end 348 includes a contact surface 349. The second leg 317, coupled to the first leg 315, is substantially non-linear in shape. The second leg 317 includes the second end 352 and may further include the bumper 324

In some examples, the second leg 317 can be integral with the first leg 315. The integral construction provides a single-piece plunger 316 that can be manufactured through injection molding, casting, or machining processes. In other examples, the first leg 315 and the second leg 317 are separate pieces. The separate pieces can be joined through various coupling methods. These coupling methods may include threaded connections, press-fit assemblies, snap-fit mechanisms, or welding processes. Adhesive bonding may also be used to secure the first leg 315 to the second leg 317. The separate piece construction allows for different materials to be used for each leg. For example, the first leg 315 may be constructed from a rigid metal material to withstand contact forces from the actuator 312. The second leg 317 may be constructed from a more flexible material to accommodate movement within the housing 14. This material selection can optimize the performance characteristics of each leg based on its specific function within the biasing assembly 306. The separate piece design also facilitates replacement of individual components. If the first leg 315 becomes worn from repeated contact with the actuator 312, only the first leg 315 needs to be replaced rather than the entire plunger 316. Similarly, if the second leg 317 requires replacement due to wear at the bumper 324, the first leg 315 can remain in service.

The first end 348 contacts a protrusion 332 of the actuator 312. In some examples, the contact surface 349 is sloped to account for relative movement (e.g., sliding engagement) between the protrusion 332 and the contact surface 349 when translating between the first configuration and the second configuration of the biasing assembly 306. In some examples, the contact surface 349 is substantially perpendicular to the handle axis 11 and substantially parallel to the first direction 31 and the insertion direction 43 in the first configuration of the biasing assembly 306.

In the first configuration, the actuator 312 is unactuated and in the second orientation, the actuator 312 is actuated. Thus, the actuator 312 includes components that allow the actuator 312 to actuate between a first position and a second position, which correspond to the first and second configurations of the biasing assembly 306. Specifically, the actuator 312 includes components that allow the actuator 312 to actuate between a first and a second configuration at least partially within the housing 14 (e.g., within the handle 16). For example, the actuator 312 includes a pinned end 328, a sliding end 330, and the protrusion 332. The protrusion 332 is disposed inside the housing 14. However, in other examples, the protrusion 332 may be disposed outside of the housing 14.

The pinned end 328 of the actuator 312 is rotatably coupled to the housing 14 via actuator pins 336. Thus, when the actuator 312 is depressed (e.g., moved, pulled, etc.) by a user in an actuation direction 340, the actuator 312 rotates about the pinned end 328. Thus, the sliding end 330 travels in an arc relative to the pinned end 328 and is recessed into the housing 14. In some examples, the actuation direction 340 is in a direction that is substantially parallel and in the same direction as the first direction 31. In some examples, the actuation direction 340 is in a direction that is different from the insertion direction 43 (e.g., perpendicular to the insertion direction 43). As shown, the protrusion 332 is disposed along the actuator 312, opposite an interface side 344 of the actuator 312. Accordingly, a user contacts the interface side 344 of the actuator 312 to depress the actuator 312. As shown, the interface side 344 is outside of the housing 14 or handle 16. However, in some examples, the interface side 344 may be inside the housing 14 or handle 16.

In the first configuration of the biasing assembly 306, the bumper 324 is spaced from the battery pack 44 and defines a gap 356 therebetween, as shown in FIG. 3. In some examples, in the first configuration, battery-side engagement features 45 are spaced from tool-side engagement features 41 or may be in loose contact such that the battery pack 44 may move relative to the housing 14. When the actuator 312 moves in the actuation direction 340, the actuator 312 rotates about the actuator pins 336, which translates the biasing assembly 306, and the plunger 316 is translated in the biasing direction 325, toward the battery pack 44. Specifically, when the biasing assembly 306 is actuated, the second end 352 of the plunger 316 translates in the biasing direction 325, which biases the battery pack 44 away from the housing 14. In some examples, the biasing direction 325 is substantially parallel to the handle axis 11. In some examples, the biasing direction 325 is substantially perpendicular to the first direction 31.

As the plunger 316 translates along the biasing direction 325 within the housing 14, the bumper 324 translates along the biasing direction 325 to move towards the battery pack 44. Thus, as shown in a second configuration of the biasing assembly 306 in FIG. 4, there is no gap 356 between the battery pack 44 and the bumper 324. Additionally, the catches 358 prevent the plunger 316 from extending further along the biasing direction 325 than desired by contacting stops 360 of the housing 14. Thus, a user can actuate the actuator 312 until catches 358 of the housing 14 contact the stops 360, which prevent further actuation of the biasing assembly 306. Correspondingly, the catches 358 and stops 360 can limit movement of the actuator 312.

In the second configuration, the battery pack 44 is biased away from the housing 14. Specifically, the biasing force, supplied at the bumper 324 (e.g., plunger 316), is applied to the battery-side terminal 47. Advantageously, the translation of the battery pack 44 along the biasing direction 325 may reduce movement of the battery pack 44 during operation. Specifically, the translation of the battery pack 44 along the biasing direction 325 may reduce relative movement between the battery-side engagement features 45 and the tool-side engagement features 41, as well as reduce relative movement between the battery-side terminals 47 and the tool-side terminals 39. By reducing relative motion between the battery-side terminals 47 and the tool-side terminals 39, which ensures a good electrical connection, operating temperatures can be better controlled because electrical resistance remains lower, which reduces heat generation and decreases the chance of a shutdown of the power tool due to high temperatures.

In the example depicted in FIGS. 3-5, the bumper 324 is comprised of rubber material. The rubber material provides several advantageous properties for the biasing assembly 306. When the plunger 316 translates towards the battery pack 44 (e.g., the battery-side terminal 47), the bumper 324 may resiliently deform. This deformation creates friction between the bumper 324 and the battery pack 44. The friction limits relative motion of the battery pack 44 relative to the housing 14 and the handle 16.

The compressible nature of the bumper 324 allows contact to be maintained as the plunger 316 moves between the first and second positions. The compressible nature also controls the magnitude of the biasing force. The rubber material can compress under load to accommodate variations in battery pack dimensions or positioning tolerances. This compression ensures consistent contact pressure even when manufacturing tolerances vary between different battery packs 44. The resilient deformation of the bumper 324 also provides vibration dampening. The rubber material absorbs energy from vibrations generated during tool operation. This absorption reduces the transmission of vibrations between the battery pack 44 and the housing 14. The dampening effect further enhances the stability of the electrical connection between the battery-side terminals 47 and the tool-side terminals 39. In other examples, the bumper 324 is comprised of any other material, such as plastic, or any other rigid or flexible material. Alternative materials may include thermoplastic elastomers, foam materials, or composite materials. Each material selection can be tailored to provide specific performance characteristics such as durability, chemical resistance, or temperature stability.

In some examples, the bumper 324 may include additional features (e.g., fingers, dimples, etc.). The additional features of the bumper 324 may increase friction and/or compression between the plunger 316 and the battery pack 44.

In some examples, the protrusion 332 may include elements (e.g., detent, relief feature, etc.) at the first end 348 of the plunger 316, which may reduce the force needed to retain the biasing assembly 306 in the second configuration.

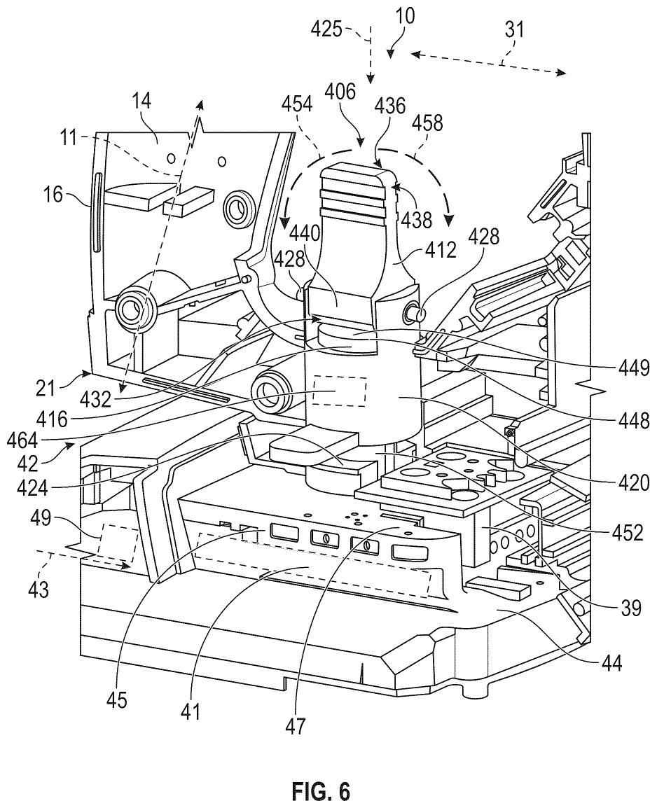

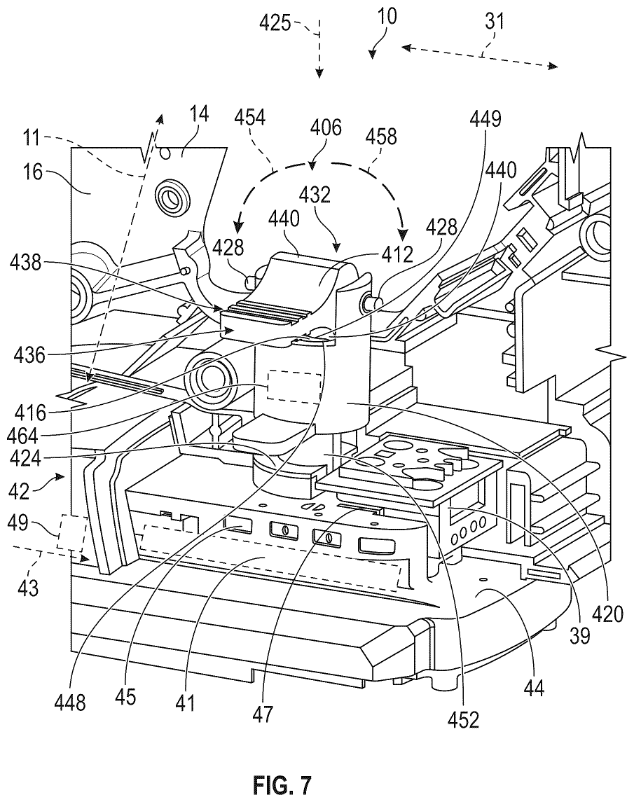

In some aspects, the power tool 10 may include a user interface that can operate independently of the trigger 38 of the power tool. For example, FIGS. 6 and 7 illustrate an example of a battery clamp assembly 406 (e.g., a biasing assembly) that bias the battery pack 44 away from the housing 14 of a power tool 10, where the biasing assembly 406 may operate separately from the trigger 38.

Similar to the biasing assembly 306, the biasing assembly 406 includes a plunger 416. In some examples, the biasing assembly 406 includes a plunger housing 420 and a bumper 424 (e.g., an interface, similar to the bumper 324). The plunger 416 is moveably disposed within the plunger housing 420. The plunger housing 420 is coupled to the housing 14 (e.g., at the battery receptacle 42). In some cases, the plunger housing 420 may be formed with the battery receptacle 42.

In some aspects, the plunger 416 may be configured to translated within the plunger housing 420 along a biasing direction 425. In some examples, the biasing direction 425 may be substantially parallel to the handle axis 11. In some examples, the biasing direction 425 may be substantially perpendicular to the insertion direction 43. In other examples, the biasing direction 425 is substantially perpendicular to the first direction 31.

In a first configuration of the biasing assembly 406 (e.g., FIG. 6), discussed in further detail below, the first end 448 of the plunger 416 is proximate a first end 432 of the actuator 412. Specifically, in the first configuration, a contact surface 449 of the plunger 416 is proximate the first end 432. In a second configuration of the biasing assembly 406 (e.g., FIG. 7), discussed in further detail below, the first end 448 is in contact with the first end 432 of the actuator 412. Specifically, in the second configuration, the contact surface 449 of the plunger 416 is in contact with the first end 432.

The plunger 416 defines a first end 448 and a second end 452, opposite the first end 448. The first end 448 is proximate an actuator 412 (e.g., interface, lever). The second end 452 is coupled to the bumper 424. In some examples, the second end 452 is integral with the bumper 424. In other examples, the second end 452 and the bumper 424 are separate pieces. The separate pieces are coupled via press-fit, snap-fit, or any other equivalent coupling methods. Additional coupling methods may include threaded connections, adhesive bonding, or fasteners.

The actuator 412 is rotatably coupled to the plunger housing 420 via actuator pins 428 on the first end 432 of the actuator 412. Specifically, the first end 432 of the actuator 412 includes the actuator pins 428 that are received in the plunger housing 420. The actuator 412 includes a second end 436, opposite the first end 432. The second end 436 includes a user interface 438. The user interface 438 can include ribs, ridges, or grooves to help a user grab the user interface 438. Further, the actuator 412 includes a projection 440 on the first end 432. In the example of the power tool 10 depicted in FIGS. 6 and 7, the actuator 412 is a lever. However, in other examples, the actuator 412 may be a cam, a shuttle, a trigger, or any other actuator.

In the first configuration, the actuator 412 is in unactuated configuration (e.g., parallel to the biasing direction 425, released), such that the biasing assembly 406 (e.g., the plunger 416) is also unactuated. Accordingly, the bumper 424 is spaced from the battery pack 44 so the tool-side engagement features 41 and the battery-side engagement features 45 are spaced from each other or are in loose contact to be moveable relative to one another.

When the actuator 412 is actuated by a user, the actuator 412 rotates about the actuator pins 428, and the projection 440 (e.g., a cam surface) contact the plunger 416. Specifically, the projection 440 contact the contact surface 449 of the first end 448 of the plunger 416. This causes the plunger 416 to translate toward the battery receptacle 42 (e.g., battery pack 44) in the biasing direction 425. As the plunger 416 translates along the biasing direction 425, the bumper 424 also translates along the biasing direction 425, biasing the battery pack 44 from the housing 14.

Thus, in the second configuration of the biasing assembly 406, the bumper 424 is in contact with the battery pack 44 and biases the battery pack 44 from the housing 14. Specifically, the battery-side engagement features 45 and the battery-side terminals 47 are biased away from the housing 14 along the biasing direction 425.

In some examples, to release the battery pack 44 from the battery receptacle 42, the biasing assembly 406 can be in the first configuration for the battery pack 44 to be selectively decoupled from the battery receptacle 42. In other words, the actuator 412 can be in the first configuration to selectively decouple the battery pack 44 from the battery receptacle 42.

In some examples, the actuator 412 may be actuated via rotation of the user interface 438 relative to the actuator pins 428. In some examples, the actuator 412 may be rotated in a first rotation direction 454 to translate the plunger 416 between the first and second configurations. The first rotation direction 454 can be a counterclockwise rotation of the actuator 412 relative to the plunger housing 420. In other examples, the actuator 412 may be rotated in a second rotation direction 458 to translate the plunger 416 between the first and second configurations. The second rotation direction 458 can be a clockwise rotation of the actuator 412 relative to the plunger 416. Further, in some examples, the actuator 412 may be rotated in either the first rotation direction 454 or the second rotation direction 458 to translate the plunger 416 between the first and second configurations. Specifically, the actuator 412 may be rotated in either the first rotation direction 454 or the second rotation direction 458 to translate the biasing assembly 406 along the biasing direction 425. To return the biasing assembly 406 from the second configuration to the first configuration, the actuator 412 can be moved (e.g., rotated) in an opposite direction.

As described above, in the second configuration, the battery pack 44 is biased away from the housing 14, along the biasing direction 425. Specifically, the biasing force, supplied by the bumper 424 (e.g., plunger 416), is applied to the battery-side terminal 47. Advantageously, the translation of the battery pack 44 along the biasing direction 425 may reduce movement of the battery pack 44 during operation. Specifically, the translation of the battery pack 44 along the biasing direction 425 may reduce relative movement between the battery-side engagement features 45 and the tool-side engagement features 41, as well as reduce relative movement between the battery-side terminals 47 and the tool-side terminals 39. By reducing relative motion between the battery-side terminals 47 and the tool-side terminals 39, which ensures a good electrical connection, operating temperatures can be better controlled because electrical resistance remains lower, which reduces heat generation and decreases the chance of a shutdown of the power tool due to high temperatures.

In the example depicted in FIGS. 6 and 7, the bumper 424 is comprised of rubber material. Thus, when the plunger 416 translates towards the battery pack 44, the bumper 424 may resiliently deform, creating friction between the bumper 424 and the battery pack 44, limiting relative motion of the battery pack 44 relative to the housing 14 and the handle 16. In other non-limiting examples, the bumper 424 is comprised of any other material, such as plastic, or any other rigid or flexible material.

In some examples, the bumper 424 may include additional friction features (e.g., fingers, dimples, ridges, grooves, etc.), which may increase friction and/or compression between the plunger 416 and the battery pack 44. For example, friction features can increase the amount of contact area. In some cases, the friction features can increase compliance of the bumper 424, which may improve dampening, or improve compliance of the bumper 424 to provide progressive or constant engagement force, as may improve feel on the trigger. The friction features may be arranged in patterns across the bumper 424. The patterns may include regular arrays, random distributions, or geometric configurations. The size and spacing of the additional features may be selected based on the desired contact characteristics.

In some examples, the actuation of the actuator 412 may connect the tool-side terminals 39 of the power tool 10 with battery-side terminals 47 of the battery pack 44. Accordingly, in some examples, in the first configuration, the tool-side terminals 39 may be spaced from the battery-side terminals 47 in the first configuration and the tool-side terminals 39 may contact the battery-side terminals 47 in the second configuration. Thus, when the actuator 412 is in the first orientation, power may not be provided to the power tool 10 via the battery pack 44. Similarly, in such examples, when the actuator 412 is in the second orientation, power may be provided to the power tool 10 via the battery pack 44, and, thus, a user may operate the power tool 10. In other cases, the terminals 39, 47 may be in contact in both the first configuration and the second configuration. In other examples, when the actuator 412 is in the first orientation, power may be provided to the power tool 10 via the battery pack 44. Thus, in such examples, power may be provided to the power tool 10 such that a user may operate the power tool 10 when the biasing assembly 406 is in either the first or second configuration.

In some examples, the biasing assembly 406 may include a sensor 464 (e.g., a switch, a hall sensor, etc.) to detect (e.g., sense) a configuration of the actuator 412. For example, the sensor 464 may detect if the actuator 412 is in the first configuration. Further, the sensor 464 may detect if the actuator 412 is in the second configuration. In some examples, if the sensor 464 detects that the actuator 412 is in the first configuration, the power tool 10 may not be permitted to operate. In other words, if the actuator is not in the second configuration, a user may not be able to operate the power tool 10. In some examples, the sensor 464 may be in electrical communication with a controller (e.g., a controller 98).

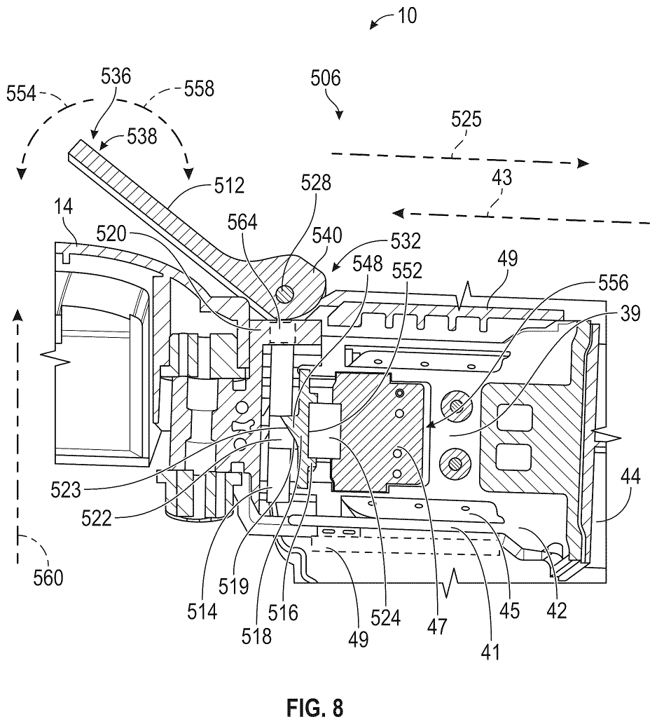

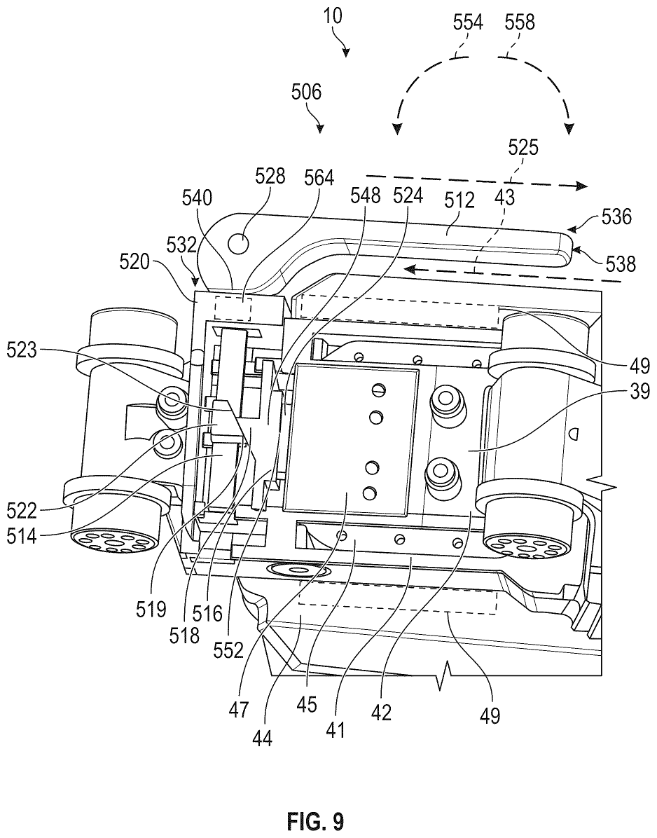

FIGS. 8 and 9 illustrate another example of a battery clamp assembly 506 (e.g., biasing assembly) that bias the battery pack 44 away from the housing 14 of a power tool 10, where the biasing assembly 406 may operate separately from the trigger 38. In some examples, the biasing assembly 506 can secure the battery pack 44 within the housing 14, similar to the latches 49. In other examples, the latches 49 secure the battery pack 44 within the housing and the biasing assembly 506 provides a biasing force to the battery pack 44 after the battery pack 44 is secured in the housing 14.

Similar to the biasing assembly 406, the biasing assembly 506 includes a plunger 516. In some examples, the biasing assembly 506 also includes an actuator arm 514 (e.g., intermediate plunger) and an interface 524 (e.g., a bumper). At a first end 548, the plunger 516 includes a plunger protrusion 518, and at a second end 552, opposite the first end 548, the plunger 516 contacts the interface 524. The actuator arm 514 is coupled to an actuator 512 (e.g., interface, lever) and is slidably disposed within the housing 14. The plunger 516 slidably contacts the actuator arm 514, and further contacts the interface 524. Specifically, an actuator protrusion 522 of the actuator arm 514 contacts the plunger protrusion 518 of the plunger 516. Further, the actuator protrusion 522 includes a sloped surface 523 (e.g., a first cam surface) and the plunger protrusion 518 includes a sloped surface 519 (e.g., a second cam surface). Continuing, the sloped surface 523 of the actuator protrusion 522 is sloped opposite of the sloped surface 519 of the plunger protrusion 518. Thus, as the actuator arm 514 translates towards the actuator 512 (e.g., by rotation of the actuator 512), the plunger 516 translates in a direction away from the actuator arm 514 (e.g., biasing direction 525).

As shown in FIGS. 8 and 9, the actuator 512 is rotatably coupled to the actuator arm 514 via actuator pins 528 on a first end 532 of the actuator 512. The first end 532 of the actuator 512 includes the actuator pins 528 that are received in the actuator arm 514. The actuator 512 includes a second end 536, opposite the first end 532. The second end 536 includes a user interface 538. Further, the actuator 512 includes a projection 540 on the first end 532. In the example embodiment of the biasing assembly 506 depicted in FIGS. 8 and 9, the actuator 512 is a lever. However, in other examples, the actuator 512 may be a cam, a shuttle, a trigger, or any other actuator.

In a first configuration (e.g., unswitched, unpressed, unflipped, unactuated, released, etc.) of the biasing assembly 506, shown in FIG. 7, the actuator 512 is in unactuated configuration (e.g., a vertical configuration relative to the battery pack 44, released), the biasing assembly 506 is in an unactuated configuration, thus, and the actuator arm 514 is also unactuated (e.g., in an unactuated configuration, released). Thus, the plunger 516 is also unactuated. In some examples, and as described above, the interface 524 is in in contact with the battery-side terminals 47. Further, the battery-side terminals 47 are spaced from the tool-side terminals 39, defining a gap 556.

When the actuator 512 is actuated by a user, the actuator 512 rotates about the actuator pins 528, and the projection 540 contacts a plunger housing 520. In some examples, a friction force is defined when the projection 540 contacts the plunger housing 520, which locks the actuator 512 in a second configuration. When the projection 540 contacts the plunger housing 520, the actuator arm 514 translates toward the actuator 512 within the plunger housing 520 along an actuation translation direction 560. Thus, as the actuator arm 514 translates toward the actuator 512, the sloped surface 523 of the actuator protrusion 522 translates toward the actuator 512. In some examples, the actuation translation direction 560 is substantially perpendicular to at least one of the insertion direction 43, and the handle axis 11.

As the sloped surface 523 translates towards the actuator 512, the sloped surface 519 of the plunger protrusion 518 translates away from the actuator arm 514 since the sloped surface 523 of the actuator arm 514 presses against the sloped surface 519, biasing the plunger 516 in the biasing direction 525 (e.g., a direction away from the actuator arm 514). In some cases, the biasing direction 525 is substantially orthogonal to at least one of the insertion direction 43, the handle axis 11 of power tool 10, and the first direction 31.

In a second configuration of the biasing assembly 506, shown in FIG. 9, the actuator 512 is in an actuated configuration so that the interface 524 is in contact with the battery-side terminals 47, which are in contact with the tool-side terminals 39. This contact applies the biasing force to the battery pack 44 to bias the battery pack 44 from the housing 14, along the biasing direction 525, via the plunger 516. Advantageously, the translation of the battery pack 44 away from the housing 14 (and handle 16) may reduce any vibration of the battery pack 44 and battery receptacle 42 during operation. Said differently, friction between the interface 524 and the battery pack 44 may reduce relative motion between the housing 14 and the battery pack 44. Additionally, and as stated above, by reducing relative motion between the battery-side terminals 47 and the tool-side terminals 39, which ensures a good electrical connection, operating temperatures can be better controlled because electrical resistance remains lower, which reduces heat generation and decreases the chance of a shutdown of the power tool due to high temperatures.

In some examples, the actuator 512 may be actuated via rotation of the user interface 538 relative to the actuator pins 528. In some examples, the actuator 512 may be rotated in a first rotation direction 554 to translate the plunger 516. The first rotation direction 554 can be a counterclockwise rotation of the actuator 512 relative to the plunger housing 520. In other examples, the actuator 512 may be rotated in a second rotation direction 558 to translate the plunger 516. The second rotation direction 558 can be a clockwise rotation of the actuator 512 relative to the plunger 516. Further, in some examples, the actuator 512 may be rotated in either the first rotation direction 554 or the second rotation direction 558 to translate the plunger 516. Specifically, the actuator 512 may be rotated in either the first rotation direction 554 or the second rotation direction 558 to translate the biasing assembly 506 along the biasing direction 525. To return the biasing assembly 506 from the second configuration to the first configuration, the actuator can be moved in an opposite direction.

In the example depicted in FIGS. 8 and 9, the interface 524 is comprised of rubber material. Thus, when the plunger 516 translates towards the battery pack 44, the interface 524 may resiliently deform, creating friction between the interface 524 and the battery pack 44, limiting relative motion of the battery pack 44 relative to the housing 14 and the handle 16. In other non-limiting examples, the interface 524 is comprised of any other material, such as plastic, or any other rigid or flexible material. In some examples, the interface 524 may include additional features (e.g., fingers, dimples, etc.). The additional features of the interface 524 may reduce friction and/or compression between the plunger 516 and the battery pack 44.

In some examples, the biasing assembly 506 may include a sensor 564 (e.g., a switch, a hall sensor, etc.) to detect (e.g., sense) a configuration of the actuator 512. For example, the sensor 564 may detect if the actuator 512 is in the first configuration. Further, the sensor 564 may detect if the actuator 512 is in the second configuration. In some examples, if the sensor 564 detects that the actuator 512 is in the first configuration, the power tool 10 may not be permitted to operate. In other words, if the actuator is not in the second configuration, a user may not be able to operate the power tool 10. In some examples, the sensor 564 may be in electrical communication with a controller (e.g., a controller 98).

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as examples of the invention, of the utilized features and implemented capabilities of such device or system.

The above detailed description is to be read with reference to the figures, in which like elements in different figures have like reference numerals. The figures, which are not necessarily to scale, depict selected examples and are not intended to limit the scope of examples of the disclosed technology. Skilled artisans will recognize the examples provided herein have many useful alternatives and fall within the scope of examples of the disclosed technology.

It is to be understood that the invention is not limited in its application to the details of construction and the arrangement of components set forth in the following description or illustrated in the following drawings. The invention is capable of other examples and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise limited or defined, “substantially parallel” indicates a direction that is within ±10 degrees of a reference direction (e.g., within ±7 degrees or ±5 degrees), inclusive. Similarly, unless otherwise limited or defined, “substantially perpendicular” or “substantially orthogonal similarly indicates a direction that is within ±10 degrees perpendicular of a reference direction (e.g., within ±7 degrees or ±5 degrees), inclusive.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Also as used herein, unless otherwise defined or limited, directional terms are used for convenience of reference for discussion of particular figures or examples or to indicate spatial relationships relative to particular other components or context, but are not intended to indicate absolute configuration. For example, references to downward, forward, or other directions, or to top, rear, or other positions (or features) may be used to discuss aspects of a particular example or figure, but do not necessarily require similar configuration or geometry in all installations or configurations.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±10%, inclusive. Where specified, “substantially” can indicate in particular a variation in one numerical direction relative to a reference value. For example, “substantially less” than a reference value (and the like) indicates a value that is reduced from the reference value by 10% or more, and “substantially more” than a reference value (and the like) indicates a value that is increased from the reference value by 10% or more.

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

The previous description of the disclosed examples is provided to enable any person skilled in the art to make or use the invention. Given the benefit of this disclosure, various modifications to these examples will be readily apparent to those skilled in the art, and the principles defined herein may be applied to other examples without departing from the spirit or scope of the invention. Thus, the invention is not intended to be limited to the examples shown herein but is to be accorded the widest scope consistent with the principles and novel features disclosed herein.

What is claimed is:

1. A power tool comprising:
a housing including a battery receptacle that is configured to receive a battery pack;
a biasing assembly coupled to the housing, the biasing assembly comprising:
a plunger including a catch configured to engage with a stop coupled to the housing;
a bumper coupled to the plunger; and
an actuator coupled to the housing and configured to translate the plunger between a first position in which the bumper is disengaged from the battery pack and a second position in which the bumper is engaged with the battery pack to dampening vibrations between the battery pack and the battery receptacle.

2. The power tool of claim 1, wherein the actuator is coupled to the battery receptacle.

3. The power tool of claim 2, wherein the actuator is rotatable relative to the battery receptacle.

4. The power tool of claim 2, wherein the actuator translates the plunger in a direction that is orthogonal to an insertion direction of the battery receptacle.

5. The power tool of claim 2, wherein the actuator translates the plunger in a direction parallel to an insertion direction of the battery receptacle.

6. The power tool of claim 5, further comprising an arm that is moved by the actuator in a direction that is orthogonal to the insertion direction, the arm including a first cam surface that engages a second cam surface on the plunger.

7. The power tool of claim 2, wherein the actuator is a trigger configured to operate a motor of the power tool, the trigger actuating the biasing assembly to the second position when the trigger is pressed to run the motor and the trigger actuating the biasing assembly to the first position when the trigger is released.

8. The power tool of claim 7, wherein the plunger includes a first end coupled the actuator, a second end coupled to the bumper, and a catch is positioned between the first end and the second end, the catch engaging the housing in the second position to limit movement of the plunger.

9. The power tool of claim 8, further comprising a biasing member positioned between the housing and the first end of the plunger, the biasing member being compressed when the trigger is pressed to move the biasing assembly to the second position, and the biasing member decompressing to move the trigger and return the biasing assembly to the first position when the trigger is released.

10. A power tool configured to impart impacts to a tool bit, the power tool comprising:
a housing defining a battery receptacle configured to receive a battery pack, the battery receptacle including a tool-side engagement feature that engages a battery-side engagement feature on the battery pack to guide movement of the battery pack along an insertion direction;
a motor disposed within the housing;
a spindle disposed within the housing and rotatable by the motor;
an impact mechanism including a piston at least partially received within the spindle for reciprocation therein and a striker that reciprocates in response to reciprocation of the piston; and
a biasing assembly coupled to the housing and that is moveable between a first configuration in which the biasing assembly is disengaged from the battery pack and a second configuration in which the biasing assembly is engaged with the battery pack to apply a biasing force that forces the battery-side engagement feature into contact with the tool-side engagement feature.

11. The power tool of claim 10, wherein the biasing force is applied to a battery pack housing and is applied substantially orthogonal to the insertion direction.

12. The power tool of claim 10, wherein housing includes a handle defining a handle axis that extends from a first end of the handle to a second end of the handle, the biasing force being applied in a direction that is substantially parallel to the handle axis.

13. The power tool of claim 10, wherein the biasing assembly includes a plunger that engages with the battery pack in the second configuration and a user interface that moveable between a first position to place the biasing assembly in the first configuration and a second position to place the biasing assembly in the second configuration.

14. The power tool of claim 13, wherein biasing assembly includes a bumper coupled to the plunger to engage with the battery pack.

15. The power tool of claim 14, wherein the bumper includes dimples that engage the battery pack.

16. The power tool of claim 15, wherein a biasing component contacts the plunger at an end opposite the bumper.

17. The power tool of claim 13, wherein the user interface is a trigger of the power tool that controls a supply of electrical current to the motor.

18. The power tool of claim 13, wherein the user interface is a lever that is actuated independent of a trigger of the power tool.

19. The power tool of claim 13, wherein the user interface is a cam lever that rotates to move the plunger to move the biasing assembly between the first configuration and the second configuration.

20. A method of operating a power tool, the method comprising:
actuating a trigger to operate a motor of the power tool, the motor positioned within a housing that defines a battery receptable configured to receive a battery;
moving a biasing assembly to a first position relative to the housing where the biasing assembly is configured to disengage the battery when the battery is received in the battery receptacle; and
moving the biasing assembly to a second position relative to the housing where the biasing assembly is configured to engage the battery to dampen vibrations between the battery and the housing when the battery is received in the battery receptacle.
